(19) United States
(12) Patent Application Publication
(10) Pub. No.: US 2007/0251334 A1
(43) Pub. Date: Nov. 1, 2007

(54) Method and apparatus for collecting samples of a solid or slurry flowing in a pipe

(76) Inventors: David J. Akers JR., Indiana, PA (US); Clifford E. Raleigh JR., Home, PA (US); Glenn A. Shirey, Delmont, PA (US); David A. Urchek, Blairsville, PA (US)

Correspondence Address: JAMES L. BEAN, Suite One, 1423 Powhatan Street, Alexandria, VA, 22314, US

(21) Appl. No.: 11/414,389

(22) Filed: May 1, 2006

(51) Int. Cl. G01N 1/20

(52) U.S. Cl. 73/863.71

(57) ABSTRACT

A method of and apparatus for collecting samples from a flowing stream in which an elongated sampling device including inner and outer concentric, relatively rotatable tubular members is positioned in and extends across the stream. The tubular members each have a longitudinally extending slot at least as long as the transverse width of the stream, with the slots being wider, and preferably at least about three times wider than the dimension of the largest particles contained in the stream. To take a sample, the inner tubular member is rotated to position its slot facing upstream, then the outer tubular member is rotated to position its slot in alignment with the slot in the inner tubular member to permit material from the stream to flow into the inner tubular simultaneously across the full width of the stream. When samples are not being taken, at least the outer tubular member is rotated to so that its slot faces downstream.

This invention was made with Government support under Contract No. DE-FC26-03NT41788 awarded by the Department of Energy. The Government has certain rights in this invention.

### BACKGROUND OF THE INVENTION

1. Field of the Invention

This invention relates to an improved method of and apparatus for collecting samples of solids or slurries from a stream flowing in a pipe or other flow containment device or from a free-flowing stream.

2. Description of the Prior Art

Collecting samples that are representative of material flowing through flow containment devices such as pipes is known and is critical to the efficient operation of many industrial facilities such as coal cleaning and mineral processing plants. These samples are used, for example, to diagnose equipment performance, determine optimal process set-points, and for quality control of the final product.

When heterogeneous solids, such as ground or crushed coal, flow through a pipe, chute, or other device for containing a flow of material either as dry solids or a slurry, the particles tend to stratify within the containment device because of differences in particle size and density. This stratification is accelerated by bends or curves in the flow containment device (hereinafter, pipe) that apply centrifugal force to the flow. When the flow in a pipe is not homogeneous, collecting samples that are representative of the entire flow is very difficult, especially if the flow rate is high as is the normal case in commercial facilities such as coal cleaning plants. As samples are by definition intended to be representative of the entire population, the term representative sample is somewhat redundant will not be used further. Also, as used herein, the term slurry should be construed to mean particles suspended in a liquid such as water or in air.

Currently, there are three commonly used options for collecting a sample from a low pressure or gravity flow stream in a pipe. First, a sample may be collected at the pipe discharge by moving a sampling device through the flow as it falls; however pipe discharges are normally enclosed or shrouded to prevent splashing or dusting, and the discharges are frequently located in an inaccessible area of the plant so that this option may not be available. Even where the discharge is accessible, the equipment is expensive to produce and difficult to install. This method can also present safety issues.

Second, it is possible to collect a sample by intermittently diverting the full flow from the pipe to a sample container, usually through a flexible hose. However, this option requires the installation of special valves and may not be feasible especially with the high flow rates normally encountered in commercial plants because of safety concerns associated with manually diverting a high flow. Also, the volume of a normal sample container may be quickly exceeded, and it is necessary to store a large quantity of material during the time between initially diverting the flow and equilibration of the flow to allow sampling. Further, diverting an entire flow may cause a process upset by starving downstream equipment of feed.

Third, a short section of pipe can be removed to produce a short uncontained stream, and a mechanical sampler installed to intersect the uncontained flow. This option is not always practical because of lack of space in the plant and the sampling equipment is expensive to purchase and install.

Because of the difficulty and expense of collecting a sample from a pipe, industry often relies on the use of devices that are known to produce a specimen rather than a sample. For example, an opening is sometimes made in the pipe, for example, in the bottom of a sloped or inclined pipe, and a smaller pipe inserted to collect slurry. Because only the material flowing in the area of the smaller pipe inlet, for example, near the bottom of the pipe, is collected, the specimen will contain not only particles whose size and density are different than those in the stream as a whole, but also will contain a different proportion of the fluid in the slurry.

In other cases, a scoop or small pipe (sometimes called a sample thief) is inserted into the flow in a pipe to divert slurry into a container. In this case, slurry collection begins as soon as the thief enters the flow and collection continues as the thief moves across the flow. Because the thief collects slurry near the insertion point for as long as it is in the flow, but only collects slurry opposite the insertion point when fully inserted, the total slurry collected contains proportionally more slurry from the side of the pipe near the insertion point.

U.S. Pat. Nos. 3,747,411 and 4,479,393 each disclose a suspension sampling device which may be mounted on a pipe and which includes a sampling probe which can be projected into and withdrawn from a pressurized suspension stream flowing in the pipe.

U.S. Pat. Nos. 5,905,213 and 6,792,818 each disclose a valve arrangement for a sampling system mounted on a pipe.

### SUMMARY OF THE INVENTION

It is a primary object of the present invention to provide an improved method of and apparatus for collecting a sample from a stream of material flowing in a pipe or from a free flowing coherent stream, with the ease of operation and low cost of collecting a specimen with a sample thief.

In the attainment of the foregoing and other objects and advantages of the invention, an important feature resides in providing an apparatus for and a method of collecting a product sample from a stream of the product by inserting a sampling probe composed of two elongated coaxial cylinders disposed one inside the other into the stream to be sampled. The inner cylinder contains an elongated slot having width at least slightly larger and preferably about three times larger than the size of the largest particles in the flow and the outer cylinder contains a slot of similar width and preferably slightly more narrow than the slot in the inner cylinder. Both slots are along the long axis of the cylinder and are at least as long as the transverse width of the stream of the product in the area being sampled.

The coaxial cylinders extend through the stream and are supported for rotation about their respective axes. When the stream is contained in a pipe, the sampling device preferably extends through openings in the pipe wall and is mounted in substantially fluid-tight relation relative to the pipe wall and for rotation of the two cylinders about their respective longitudinal axes. Two levers or other suitable devices mounted one on each cylinder outside the pipe are provided for rotating the cylinders about their respective axes to selectively align or misalign the slits with one another and with the direction of flow within the pipe.

The smaller diameter cylinder projects outwardly from one end of the larger cylinder and is connected to a suitable conduit, for example a flexible hose, leading to a sample collection container. A suitable valve, preferably a manually operable valve, may be provided to open and close the conduit to control the flow of sample material from the sampling apparatus and to prevent or minimize leakage when the device is not in use.

The apparatus may be mounted on a pipe in a position extending generally diametrically across the pipe and remain in position even when samples are not being taken, or alternatively it may be withdrawn from the stream flowing in the pipe, in which case the mounting openings are preferably closed by a plug or cap until another sample is to be collected although it may not be necessary to close these openings when the stream is not pressurized. When the apparatus remains in position extending across the pipe and no sample is being taken, the outer cylinder is rotated to a position in which the slot in its wall is directed downstream to produce minimum turbulence in the stream and to prevent the accumulation of particles which could enter the smaller cylinder upon the next use of the device to take a sample.

### BRIEF DESCRIPTION OF THE DRAWINGS

The foregoing and other features of the invention will become apparent from the detailed description contained herein below, taken in conjunction with the drawings, in which:

FIG. 1 is a fragmentary elevation view, in section, of a sampling apparatus embodying the invention installed in a vertical pipe;.

FIG. 2 is an isometric view of the outer cylindrical member of the sampling apparatus shown in FIG. 1;

FIG. 3 is a view similar to FIG. 2 of the inner cylindrical member;

FIG. 4 is a sectional view taken along line 4-4 of FIG. 1; and

FIG. 5 is an exploded isometric view of a mounting assembly shown in FIG. 1.

### DESCRIPTION OF THE PREFERRED EMBODIMENT

Referring now to the drawings in detail, a sampling apparatus according to the invention is indicated generally by the reference numeral 10, and includes an outer cylindrical member 12 and an inner cylindrical member 14 mounted within the outer cylinder, each for independent rotation about their common longitudinal axes. The outer diameter of the cylindrical member 14 is substantially equal to the inner diameter of the cylindrical member 12 so that the two members are freely rotatable relative to one another. The apparatus 10 is illustrated installed in a substantially vertical pipe 16 for containing a flow of material to be sampled such as a slurry of coal particles in water from a coal washing operation.

An elongated slot 18 having a length at least as great as the diameter of pipe 16 is formed in the sidewall of outer cylinder 12. The slot 18 has a width, measured in the circumferential direction, which is substantially greater, and preferably at least about three times greater, than the size of the largest particles flowing in pipe 16. A similar slot 20 is formed in the inner cylinder 14, with the width of slot 20 being at least slightly greater, and preferably at least about three times greater, than the maximum diameter or width of the largest particles flowing in pipe 16 but preferably no smaller, and more preferably at least slightly larger than the width of the slot 18 in the outer cylinder for reasons pointed out herein below.

Outer cylinder 12 has a generally radially extending bar, or lever 24 rigidly joined to and extending radially outwardly from one end in position to be grasped to manually turn cylinder 12 about its longitudinal axis in a manner described below. Similarity, inner cylinder 14 has a generally radially extending turning lever 28 rigidly joined thereto.

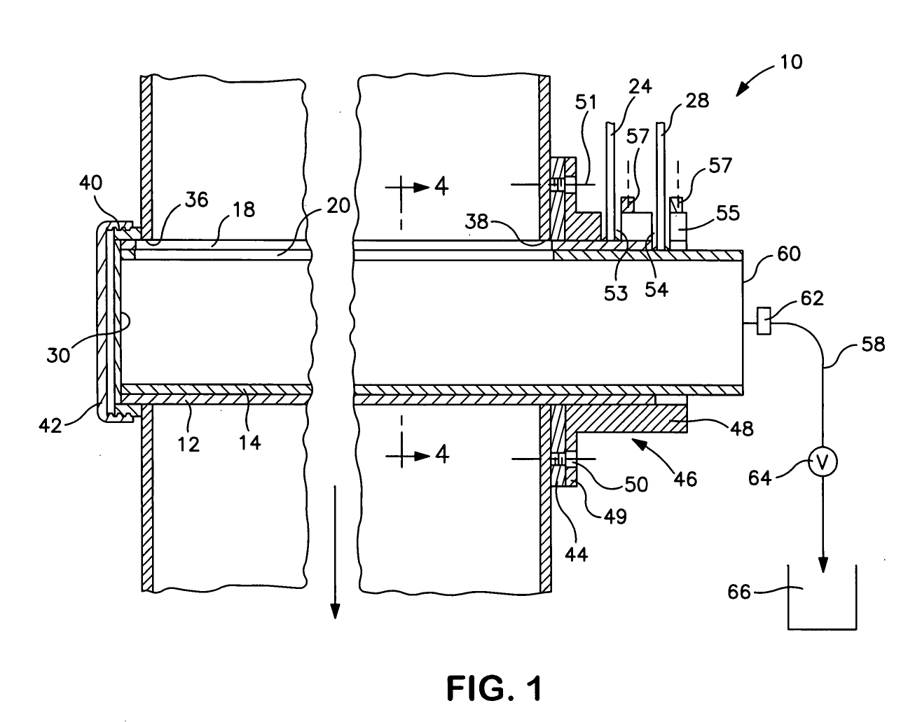

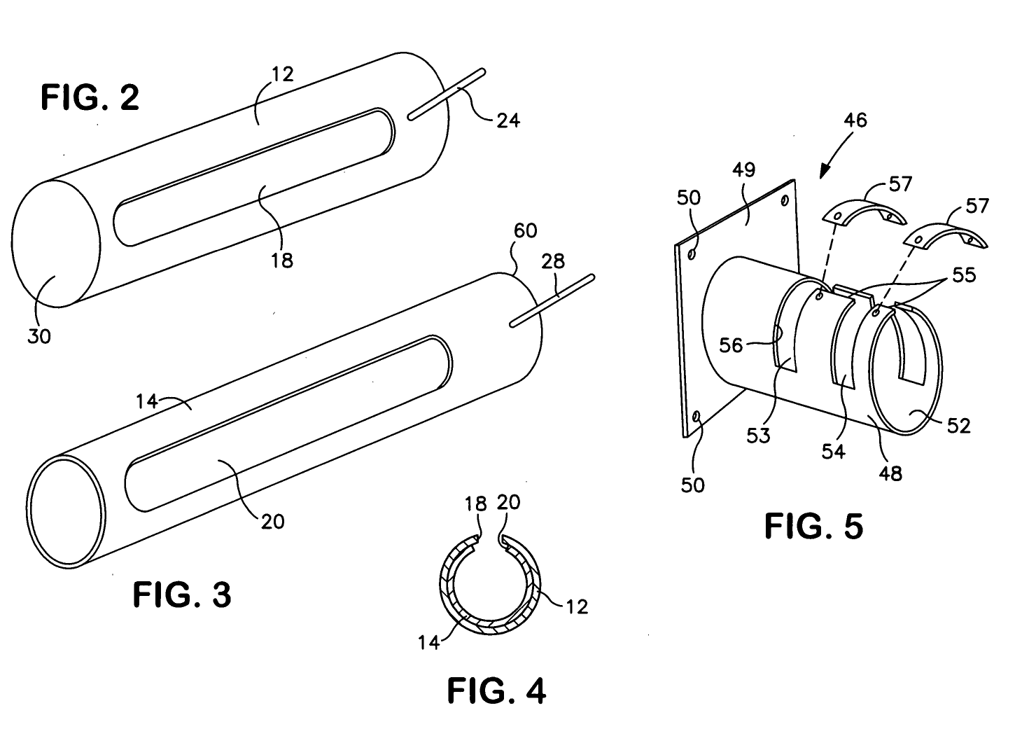

The end of outer cylinder 12 opposite lever 24 may be closed by suitable means such as a threaded plug or a disc-like member 30 as shown in FIGS. 1 and 2, or alternatively may be open. Also, an annular groove (not shown) for receiving an O-ring seal or packing gland may be provided in cylinder 12 to form a fluid-tight seal between cylinders 12 and 14 in the vicinity of levers 24 and 28 when the inner cylinder is in position inside outer cylinder.

To use the sampling apparatus 10 to sample a product stream flowing in a pipe 16, for example a vertical or substantially vertical pipe, a pair of sampling openings or ports 36, 38 are formed in the pipe in substantially diametrically opposed relation to one another in position to receive and support the end portions of cylinder 12. To prevent or minimize leakage, a short pipe nipple or annular ring 40 may be welded to and extends outwardly from pipe 16 at the opening 36 to provide support for the closed end of outer cylinder 12. The pipe nipple 40 may be closed by suitable means such as a threaded pipe cap 42 to prevent leakage from within the pipe 16 or to provide a closure for the end of inner cylinder 14 when the adjacent end of cylinder 12 is not closed.

As best seen in FIG. 1, an annular flange or weldment 44 is welded to pipe 16 and surrounds port 38 for releasably mounting and rotatably supporting the outlet end of the sampling apparatus on the pipe 16.

As best seen in FIG. 5, the cylinders 12 and 14 are retained in the ports 36, 38 and supported for limited rotation about their respective axes by a support sleeve structure 46 including a generally cylindrical tubular body 48 rigidly joined to or integrally formed with a mounting flange 49 having a plurality of openings 50 therein for receiving threaded fasteners indicated schematically at 51 in FIG. 1 for releasibly attaching flange 49 to weldment 44. The cylindrical body 48 has an inner bore 52 generally corresponding to the outer diameter of outer cylinder 12. A pair of axially spaced arcuate slots 53, 54 are formed in and extend through body 48, with the slots 53, 54 extend through body 48, with the slots 53, 54 extending in the circumferential direction about an arc of at least slightly greater than 180°.

A longitudinal extending slot 55 is also formed in the body 48 in a position to intersect, arcuate slots 53, 54, with the longitudinal and arcuate slots each being dimensioned to receive the levers 24 and 28.

To assemble the sampling apparatus 10 the inner cylinder 14 is telescoped into outer cylinder 12 and the cylinders are telescoped through tubular body until lever 24 abuts the end wall 56 of annular slot 53 and lever 28 is positioned in slot 54. The assembly is inserted through weldment 44 until the mounting flange 49 engages weldment 44 and the opposite end of outer cylinder 12 projects through opening 36 and into the pipe nipple 40. Fasteners or bolts 51 are then inserted through openings 50 and threaded into mating threaded openings in weldment 44 to mount the assembly on pipe 16. A pair of retainer bars 57 are then mounted, as by bolts, not shown, on the outer surface of body 48, spanning the longitudinal slot 55 in position to effectively close the arcuate slots and engage levers 24, 28, respectively to retain the cylinders 12 and 14 in position spanning the pipe 16, while permitting free rotation of the cylinders about their respective axes by the levers 24 and 28 within the limits of the arcuate slots 53, 54.

A suitable drainage conduit such as a flexible hose, indicated schematically at 58, is then connected to the outwardly projecting outlet end 60 of inner cylinder 14 by suitable means such as the threaded or swivel coupling illustrated schematically at 62 in FIG. 1. A manually operated valve 64 is preferably connected in the drain conduit 58 to assure against leakage when the device is not in use.

Preferably the openings 36, 38 in pipe 16 are slightly offset in the axial direction, with opening 36 being slightly above opening 38 so that cylinders 12, 14 are inclined downwardly toward the outlet end 60 of inner cylinder 14 to provide drainage when samples are not being taken, and to promote flow of sample material when samples are being taken. The incline is preferably within the range of about 2 to about 10 degrees, and more preferably about 5 degrees.

When the sampling apparatus is not in use to take a sample, handles or levers 24 and 28 are rotated until the slot 18 is directed downstream, and slot 20 is offset or displaced circumferentially from slot 18 so that no product flows into the sampler. When a sample is to be taken, inner cylinder 14 is rotated so that the slot 20 is directed upstream, and then handle 24 is oscillated back and forth to move the slot 18 across the slot 20 at a uniform rate, allowing the sample to enter the inner cylinder 14. When sampling a liquid or a slurry, the sample material will flow out of the inner cylinder through open valve 64 and conduit 58 into a sample collecting container 66. When used to take a sample from a stream of particulate material, or containing particulate material, the width of slots 18, 20 are selected to permit material from the stream to flow into the inner cylinder 14 at the desired rate without plugging. This width must be greater than the dimension of the largest particles flowing in the stream and preferably is at least about three times the diameter or width of the largest particle. By moving slot 18 back and forth across slot 20, a sample consisting of a plurality of aliquots, or cuts, can be taken. The amount of each aliquot is controlled by the size of the slots and the speed at which the cylinder 12 rotated.

Alternatively, if desired, the slot 18 can be moved into alignment with slot 20 facing in the upstream direction and retained in that position for a time sufficient to collect the entire sample.

When the device is used to collect a sample from a stream of solid particulate material, or from a slurry which does not flow freely, the sampler can be inserted into and removed from the stream to withdraw the sample. In this case, the support arrangement (retaining bars 57) for removably mounting the sampler to the pipe are not used or are removed to permit the sample to be withdrawn. In this case, when a complete sample is collected in the inner cylinder 14, the outer cylinder 12 is rotated so that the slot 18 faces downstream and both cylinders containing the sample can be withdrawn from the sampling ports in the pipe, or alternatively, only the inner cylinder 14 can be withdrawn, taking care not to spill any of the sample.

The device can also be used to obtain a sample from a free-flowing stream, i.e., not contained in a pipe or conduit, by providing a support corresponding to sampling ports 36, 38, for the outer cylinder at each side of the stream.

Where extreme accuracy is desired or necessary, a plurality of the sampling devices may be provided at positions spaced from one another, along the stream and oriented at different angles around the stream in a spoke-like pattern. It is also possible to use a plurality of the devices, again preferably offset axially of the pipe relative to one another, to collect samples from different sections or different levels of a pipe. For example, in an inclined pipe, it may be desirable to sample the product near the bottom of the pipe, near the top, or at various positions in between. In this regard, while the invention has been described primarily with reference to sampling a substantially vertically flowing stream, the apparatus may be employed in sampling streams flowing in a pipe disposed at any angle. Also it is possible to mount the sampling device in the manner described above in a rotatable section of pipe so that the sampler can be rotated to any desired position around the circumference of the pipe.

In order to confirm that the sampling apparatus produces a representative sample, its performance was compared to a full flow diversion sample during testing at a commercial Coal Cleaning Plant in Pennsylvania. While full flow diversion samples are difficult to collect and the purchase and installation of the required valves is expensive, the sample produced by full flow diversion is widely considered to be a representative sample.

To conduit the test, the sampler was installed on a vertical pipe carrying a slurry of coal and water from the screen drain of a screen bowl centrifuge. The results of the comparative test are provided in Table 1. The column on the far right of the Table is the percent difference between the full flow diversion sample and the sampler of this invention. Of the 16 parameters evaluated, six agree within two percent and only four show a difference of greater than five percent.

TABLE 1
Comparison of Results of a Full Flow Diversion
Sample with a Sample collected by the In-Pipe
Sampler from a centrifugal screen drain.

| Parameter | Full Flow | Diversion Pipe | Difference |
|---|---|---|---|
| Moisture (wt %) | 81.05 | 79.97 | −1.33 |
| Ash (wi %) | 9.72 | 9.98 | 2.67 |
| Sulfur (WI %) | 3.15 | 3.27 | 3.81 |
| Heat Value (Btu/lb) | 14140 | 14026 | −0.61 |
| +100 Mesh (WI %) | 54.61 | 54.27 | −0.62 |
| 100 × 325 Mesh (WI %) | 30.10 | 28.73 | −4.55 |
| −325 Mesh (WI %) | 15.29 | 16.99 | 11.12 |
| +100 Mesh Ash (wt %) | 8.48 | 9.10 | 7.31 |
| 100 × 325 Mesh Ash (WI %) | 7.73 | 8.05 | 4.14 |
| −325 Mesh Ash (WI %) | 17.64 | 16.71 | −5.27 |
| +100 Mesh Sulfur (WI %) | 2.14 | 2.24 | 4.67 |
| 100 × 325 Mesh Sulfur (WI %) | 2.63 | 2.71 | 3.04 |
| −325 Mesh Sulfur (WI %) | 7.55 | 7.02 | −7.02 |
| +100 Mesh Btu/Lb | 14304 | 14164 | −0.98 |
| 100 × 325 Mesh Btu/Lb | 14445 | 14310 | −0.93 |
| −325 Mesh Btu/Lb | 12568 | 12725 | 1.25 |

While preferred embodiments of the sampling apparatus have been disclosed and described, it is believed apparent that the invention is not limited to the disclosed embodiments. For example, various arrangements may be employed to support the concentric sampling conduits for rotation about their axis and for retaining the conduits in position within a flowing stream or pipe. Accordingly, it is intended to include all embodiments which would be apparent to one skilled in the art and which come within the spirit and scope of the invention.

We claim:

1. A sampling device for obtaining representative samples from a flowing stream of heterogenous material, the device comprising
an elongated, cylindrical outer tubular member having a length greater than the transverse dimension of the stream,
a first elongated slot formed in the wall of said outer tubular member, the first elongated slot extending in the axial direction and having a length at least as great as the transverse dimension of the stream and having a substantially uniform width in the circumferential direction being greater than the width of any particles flowing in the stream,
means for rotating said outer tubular member about its longitudinal axis to change the position of said first slot relative to the direction of flow of the stream to be sampled,
an elongated, cylindrical inner tubular member mounted concentrically within said outer tubular member for relative rotation therein, the inner tubular member having a second elongated slot formed in its wall and extending in the axial direction, the second slot having a length at least as great as the transverse dimension of the stream and having a width greater than the width of any particles flowing in the stream and at least substantially as great as the width of said first slot,
said inner tubular member having an outer diameter substantially equal to the inner diameter of said outer tubular member, and
means for rotating the inner tubular member about its longitudinal axis relative to said outer tubular member whereby when the device is positioned in and extends across the stream, said second elongated slot may be selectively positioned in registry with said first elongated slot to permit material flowing in the stream to flow through said first and second elongated slots into said inner tubular member across the full width of the stream, and moved from registry to stop the flow of material from the stream into the inner tubular member.

2. The sampling device defined in claim 1, wherein the width of said second slot is equal to or greater than the width of said first slot.

3. The sampling device defined in claim 1, wherein the width of said first and second slots are at least about three times the width of any particles flowing in the stream.

4. The sampling device defined in claim 1, further comprising means closing one end of said inner tubular member, and valve means connected to the other end of said inner tubular member, the valve member being operable to selectively control flow from said inner tubular member.

5. The sampling device defined in claim 3, further comprising mounting means supporting said outer and inner tubular members in position extending transversely across the flowing stream.

6. The sampling device defined in claim 4, further comprising mounting means supporting said outer and inner tubular members in position extending transversely across the flowing stream.

7. The sampling device defined in claim 5, wherein said mounting means comprises a pair of ports formed in generally diametrically opposed sides of a pipe containing the stream.

8. The sampling device defined in claim 4, wherein said means closing one end of said inner tubular member comprises cap means closing one of said ports.

9. The sampling device defined in claim 3, wherein said device is employed to obtain a sample from an unpressurized stream, and wherein said inner tubular member is supported for axial movement within said outer tubular member whereby the inner tubular member may be removed to thereby remove a sample collected therein.

10. The sampling device defined in claim 9, wherein said means for rotating said outer tubular means is operable to position said first elongated slot facing upstream to permit a sample to be collected in said inner tubular member and in a downstream facing direction to permit said inner tubular member to be withdrawn from the outer tubular member to remove a sample without material from the stream flowing out of the outer tubular member.

11. The sampling device defined in claim 1, wherein said means for rotating said outer and said inner tubular means comprises manually operable lever means rigidly joined to said outer and said inner tubular means respectively.

12. A method for obtaining a representative sample from a flowing stream of heterogeneous material, the method comprising,
positioning an elongated sampling device across the full transverse width of the stream, the device including an outer tubular member having a first longitudinally extending slot in its wall, the first slot having a length at least as great as the transverse dimension of the stream and a width sufficient to permit the flow of the heterogeneous material therethrough, and an inner tubular rotatably supported concentrically within the outer tubular member and having a second longitudinally extending slot in its wall, the second slot having a length at least as great as the transverse width of the stream and a width sufficient to permit the flow of the heterogenous material to therethrough,
initially rotating the outer tubular member to position the first elongated slot in the downstream facing direction with the second slot covered by the first elongated tubular member,
rotating the inner tubular member to position the second elongated slot in the upstream facing direction with the second slot covered by the first elongated tubular member,
rotating the outer tubular member to position the first slot into registry with the second slot facing in the upstream-facing direction to permit a sample of material from the stream to flow through the first and second slots into the second tubular member simultaneously across the full width of the stream,
rotating the first tubular member to a position in which the second slot is again covered by the first tubular member, and
removing the sample material from the inner tubular member.

13. The method as defined in claim 12, wherein the step of rotating the first tubular member to position the first slot into registry with the second slot comprises rotating the first tubular member to pass the first slot back and forth across the second slot to alternately open and close the second slot to permit a sample consisting of a plurality of aliquots to be taken.

14. The method as defined in claim 12, further comprising rotating the outer tubular member to position the first slot in the downstream-facing direction after the sample is collected in the second tubular member.

15. The method as defined in claim 12, wherein the stream is a liquid slurry containing particulate matter, and wherein the width of both the first and second slots are selected as being greater than the width of the largest particles contained in the slurry.

16. The method as defined in claim 15, wherein the width of the first and second slots are at least about three times the width of the largest particles in the slurry.

17. The method as defined in claim 16, wherein the width of the second slot is selected as being at least slightly greater than the width of said first slot.

18. The method as defined in claim 15, wherein the step of removing the sample from the inner tubular member comprises permitting the liquid slurry sample to drain from an open end of the inner tubular member.

19. The method as defined in claim 15, wherein the step of removing the sample from the inner tubular member comprises permitting the liquid slurry sample to drain from an open end of the inner tubular member.

20. The method as defined in claim 14, wherein the stream is an unpressurized stream, and wherein the step of removing the sample from the inner tubular member comprises removing the inner tubular member and the sample from the outer tubular member after the outer tubular member has been rotated to position the first elongated slot in the downstream-facing direction.

21. The method as defined in claim 12, wherein the flowing stream is contained in a pipe, and wherein the step of positioning the sampling device in the stream comprises forming sampling ports in substantially diametrically opposed sides of the pipe, and extending the concentric inner and outer tubular members through the ports to support the device in the stream.
